(19) United States
(12) Patent Application Publication
(10) Pub. No.: US 2008/0044045 A1
(43) Pub. Date: Feb. 21, 2008

(54) Externally fused speaker terminal cup

(75) Inventor: Scott Andrew Ringo, Grapevine, TX (US)

Correspondence Address: STORM LLP, BANK OF AMERICA PLAZA, 901 MAIN STREET, SUITE 7100, DALLAS, TX, 75202, US

(73) Assignee: Dobbs-Stanford Corporation

(21) Appl. No.: 11/504,126

(22) Filed: Aug. 15, 2006

(51) Int. Cl. H04R 25/00

(52) U.S. Cl. 381/189; 381/394

(57) ABSTRACT

A fused speaker terminal cup for component attachment to a speaker enclosure and electrical connection to a speaker system is disclosed. In particular, the present invention provides a novel speaker terminal cup design in which a removable fuse is externally mounted therein for external access. In a preferred embodiment, the fuse receptacle is removable from the terminal cup to permit interchangeable fuse type selection.

### CROSS REFERENCE TO RELATED APPLICATIONS

None.

### BACKGROUND OF THE INVENTION

1. Field of the Invention

The present invention relates to the technology of electrical connection design and, in particular, to the technology of a fused speaker terminal cup for component attachment to a speaker cabinet and electrical connection to a sound system. In particular, the present invention provides a novel speaker cup terminal device in which a fuse is externally mounted therein for external access without disassembly when used in cabinet speaker systems, such as aftermarket subwoofers for automobiles and home theaters.

2. Description of the Related Art

It is well known in the automotive, aftermarket audio, and home theater industries to provide speaker enclosures for special speakers designed for the production of low and very low frequency sound. Speaker drivers for low frequency sound are known as woofers. Speaker drivers for production of very low bass frequencies are known as subwoofers. Subwoofers reproduce sound between about 20 and 120 Hz.

The reproduction of very low frequency sound requires significantly more electrical power than is required to reproduce high frequency sound. This is due to the large surface area of subwoofer speakers and the force required to move them. Amplifiers are provided for providing the required power. Depending on the application, the size and power of the amplifier will vary.

To prevent damage to system components and to avoid the hazards of overheating electrical wiring, fuses are located in the wiring circuit. The fuses are typically positioned in a fuse receptacle between the electrical supply and the accessory. The main function of the fuse is to protect the wiring circuit and electrical accessory. The fuse contains an internal conductor which provides the electrical connection between the ends of the fuse. The conductor inside the fuse is a metallic strip that has a lower melting temperature than the wiring of the circuit.

The size of the conductor is calibrated so that when the failure rating of the fuse is reached, sufficient heat will be generated to melt the conductor and break the circuit (burn the fuse). In use, if an accessory fails, the increased power demand in the circuit will exceed the failure rating of the fuse, causing the fuse to burn and separate, breaking the electrical connection. If a fuse is not used, overcurrent conditions could damage circuit elements or the electric accessory, overheat the wiring and perhaps cause a fire. The condition presents a danger to both life and property.

Different fuse designs have different rating ranges. For example, AGU fuses (glass cylinder type) are commercially available with ratings between 5 and 60 amps. MAXI fuses (blade type) are commercially available with ratings between 20 and 80 amps. The more expensive ANL fuses (wafer type) are commercially available with ratings between 60 and 300 amps. For larger loads, circuit breakers are generally required.

It is necessary for the sound system designer to provide compatible components throughout the system. For example, the amplifier must be capable of producing sufficient power to drive the speaker. The size of the speaker wire between the amplifier and speaker must be sufficient to safely carry the load generated by the amplifier.

A fuse must be selected for protection of the wire. For example, with 14 awg wire, a maximum fuse size of 15 amps is recommended. With a wire gauge of 4 awg, a maximum fuse size of 125 amps is recommended. By matching the fuse to the wire size, overcurrent of the wire is prevented.

Frequently, the load requirement of a desired speaker is very high. For example, many stereo amplifiers are rated at 2,000 or even 3,000 watts and 150 amp fuses are required for these units. Since the consumer may choose from a vast number of commercially available speakers, and match them with an amplifier, a fuse should be provided to protect the speaker driver as well. To protect their speakers, manufacturers locate fuses on the backs of the speakers which are rated below the amount of current which would damage the speaker driver.

As with the other components of a sound system, speaker enclosures may be designed to accept several different speakers from different manufacturers. As a result, fuses are generally provided attached to the speaker itself, internally within the speaker enclosures. Alternative designs, in which the manufacturer places its own speakers in its own enclosures, such as with computer speakers, may have access to the fuse built into the back of the speaker enclosure.

When speakers are assembled in customized enclosures, it is necessary to provide terminal connections between the outside of the speaker enclosure and the inside of the speaker enclosure. To resolve this problem, devices known as terminal cups are secured to an opening enclosure. Terminal connectors extend between the exterior and interior of the terminal cup. Speaker wire is connected between the speaker and the terminal connector on the interior side of the terminal cup. When the speaker enclosure is positioned as desired, speaker wiring from the amplifier is attached to the terminal connectors on the exterior side of the terminal cup to complete the electrical circuit.

A principal disadvantage of the prior art designs is that they prohibit access to the speaker fuse without unscrewing the speaker and removing it from the enclosure. Another disadvantage of the prior art designs is that system designers and consumers may have fuse type preferences which cannot be exercised because speaker manufacturers install dedicated fuse receptacles at the time the speakers are manufactured. Therefore, there is a need to develop an improved fuse system with fuse type selectability and access provided from the outside of the speaker enclosure.

### SUMMARY OF THE INVENTION

Unique to this invention, a speaker terminal cup is disclosed having a fuse receptacle located within the speaker cup. A primary advantage of the preferred embodiment of the present invention is that it permits access to the fuse without disassembly of the cabinetry to which the terminal cup is attached. A second advantage of the present invention is that it permits exchangeability of fuse types as may be selected by the system designer or consumer.

As referred to hereinabove, the “present invention” refers to one or more embodiments of the present invention which may or may not be claimed, and such references are not intended to limit the language of the claims, or to be used to construe the claims in a limiting manner.

In the preferred embodiment of the present invention, a fused speaker enclosure terminal cup is disclosed. The terminal cup has an interior and an exterior. A pair of terminal connectors is attached to the base, and extend between the interior and exterior sides of the base. A fuse receptacle is located on the base. The fuse receptacle has a front side substantially aligned with the exterior side of the base, and a back side which extends to the interior side of the base.

A pair of fuse connectors extends between the front and the back of the fuse receptacle. The front of the fuse receptacle is adapted to receive a removable fuse in electrical connection between the fuse connectors. One of the fuse connectors is electrically connected to one of the terminal connectors.

In another preferred embodiment, the terminal cup has a recess located on the base, and the terminal connectors are attached in the recess. In another preferred embodiment, the base is dimensioned to cover a corresponding opening in the exterior of a speaker housing. In another preferred embodiment, the fuse receptacle is removably attached to the base of the terminal cup. In another preferred embodiment, the terminal connectors are removably attached in the recess of the terminal cup.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of an assembled speaker having a fused terminal cup in accordance with a preferred embodiment of the present invention.

FIG. 2 is an isometric view of the speaker assembly of FIG. 1, with the speaker removed.

FIG. 3 is an isometric view of the exterior side of the fused terminal cup of FIGS. 1 and 2, illustrated as removed from the speaker enclosure.

FIG. 4 is a view of the interior side of the fused terminal cup of FIG. 3.

FIG. 5 is an isometric side view of the fused terminal cup of FIGS. 3 and 4.

FIG. 6 is a top view of the fuse receptacle as removed from the fused terminal cup, and a coincident top view of the fuse shown removed from the fuse receptacle.

FIG. 7 is an end view of the fuse receptacle as removed from the fused terminal cup.

FIG. 8 is an isometric view of the interior side of the fused terminal cup of FIGS. 1, 2, and 3, illustrating the electrical connection between one terminal connector and one fuse connector.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

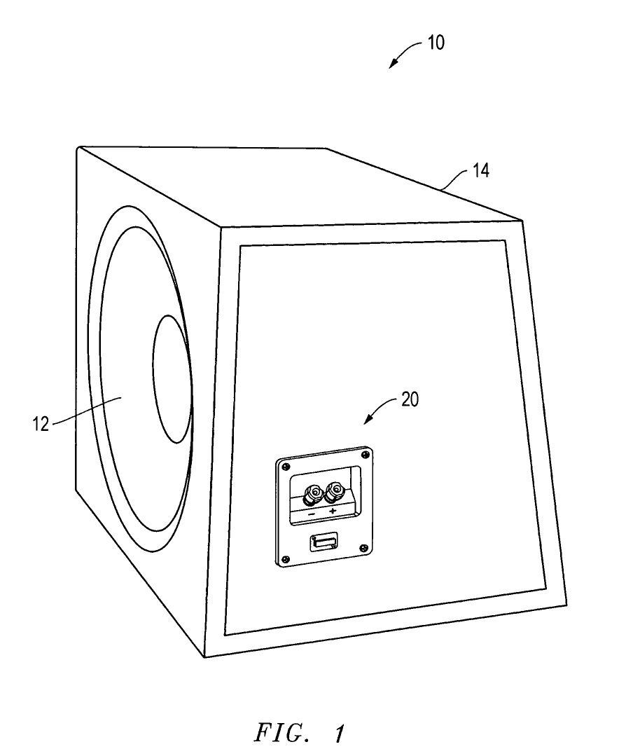

FIG. 1 is an isometric view of a speaker assembly 10, in accordance with a preferred embodiment of the present invention. Speaker assembly 10 has a speaker 12 mounted in a speaker enclosure 14. A fused terminal cup 20 is mounted on enclosure 14.

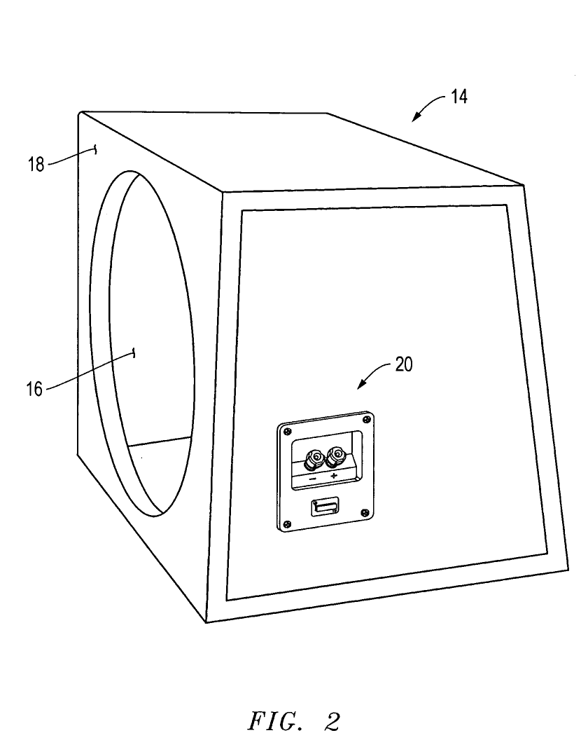

FIG. 2 is an isometric view of speaker assembly 10, with the speaker 12 removed. In this view, it can be seen that enclosure 14 has an inside 16 and an outside 18.

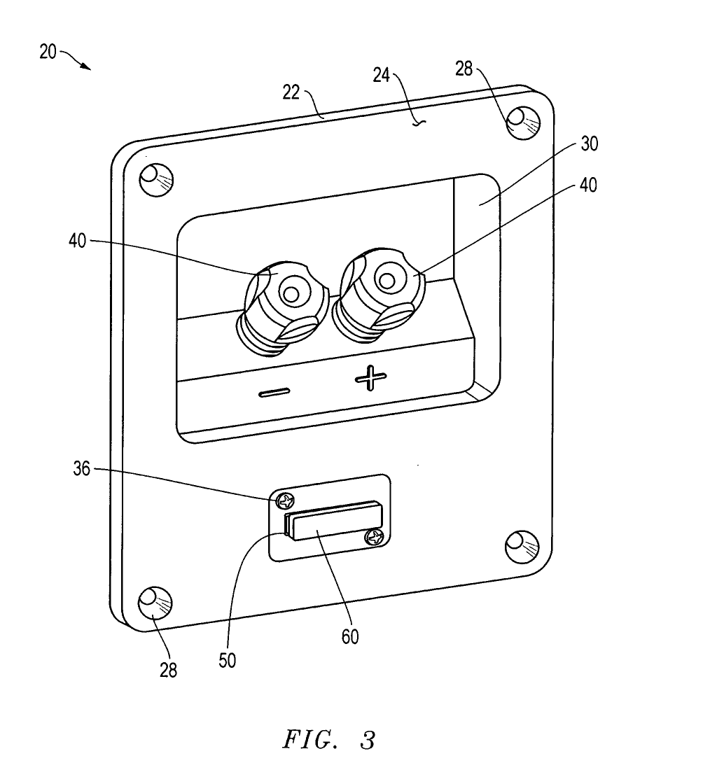

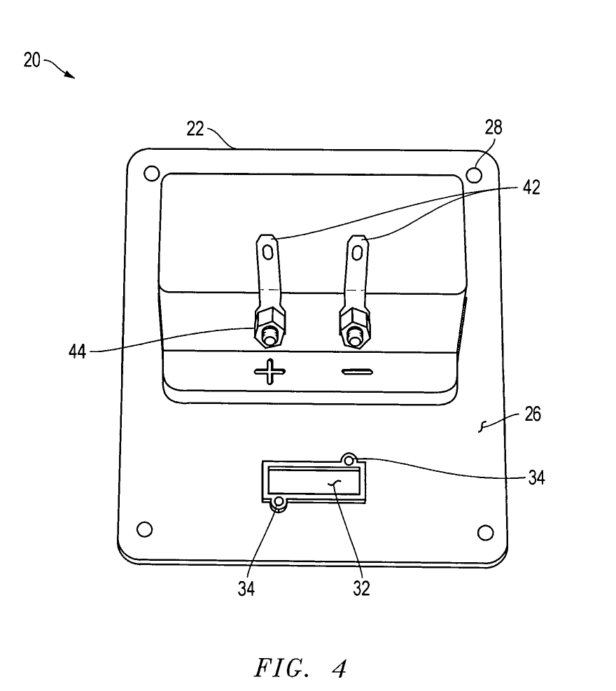

FIG. 3 is a close-up isometric view of a preferred embodiment of fused terminal cup 20. Fused terminal cup 20 has a base 22. In this view, an exterior side 24 of terminal cup 20 is visible. As best seen in FIG. 4, terminal cup 20 has an opposite interior side 26. Referring back to FIG. 3, in the preferred embodiment, holes 28 in base 22 are provided for receiving fasteners for attaching terminal cup 20 to outside 18 of speaker enclosure 14.

In the preferred embodiment, a recess 30 is formed on base 22 of terminal cup 20. A pair of terminal connectors 40 is located in recess 30. Terminal connectors 40 extend between exterior 24 and interior 26 of terminal cup 20. In the preferred embodiment, terminal connectors 40 are comprised of a separate exterior portion, shown in FIG. 3, electrically connected to an internal portion, or terminal strip 42, by terminal fasteners 44, as shown in FIG. 4.

A fuse receptacle 50 is located on base 22 of terminal cup 20. In the preferred embodiment, fuse receptacle 50 is removably attached to terminal cup 20 to permit interchangeability with multiple fuse types, such as AGU, MAXI, ANL, or another type of fuse. A fuse 60 is shown inserted into fuse receptacle 50. Fuse 60 as illustrated is a MAXI type fuse.

FIG. 4 is a view of the interior side of fused terminal cup 20 of FIG. 3. In this view, fuse receptacle 50 is shown removed. A slot 32 is formed in base 22 of terminal cup 20. In a preferred embodiment, fastener holes 34 are provided on base 22 for receiving fasteners 36 (see FIG. 3) for securing fuse receptacle 50 to base 22.

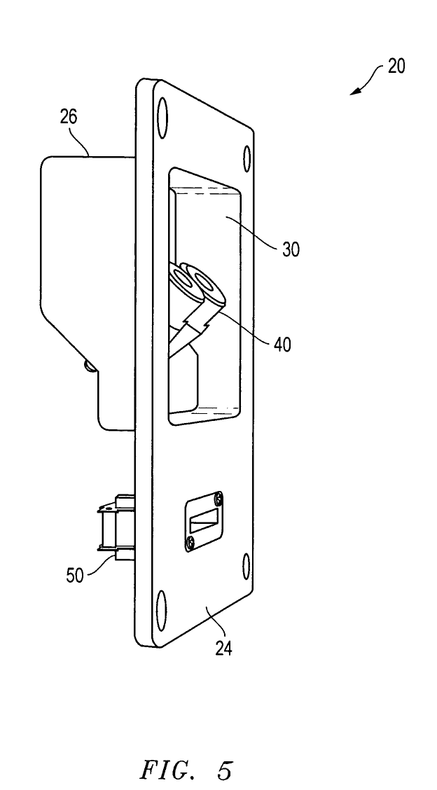

37 FIG. 5 is an isometric side view of the preferred embodiment of fused terminal cup 20, illustrating fuse receptacle 50 attached to base 22. Fuse receptacle 50 is aligned with slot 32 to permit access to fuse 60 from the outside of speaker assembly 10.

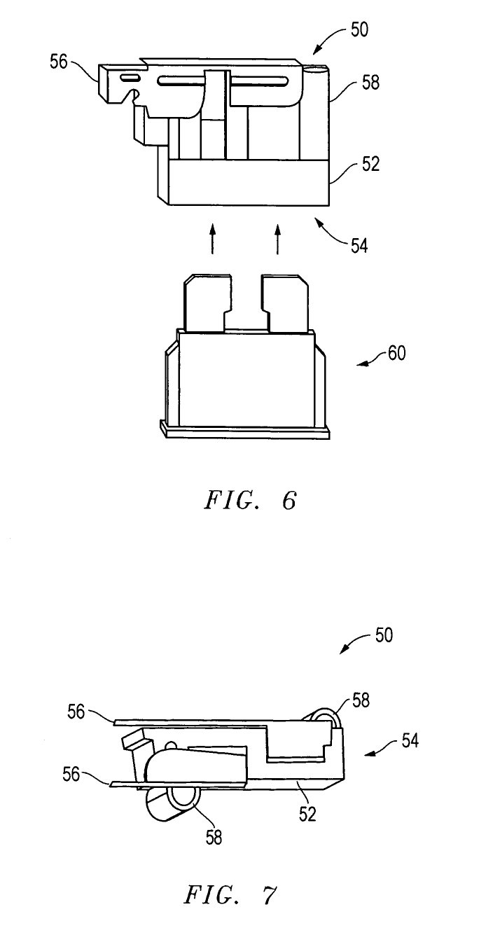

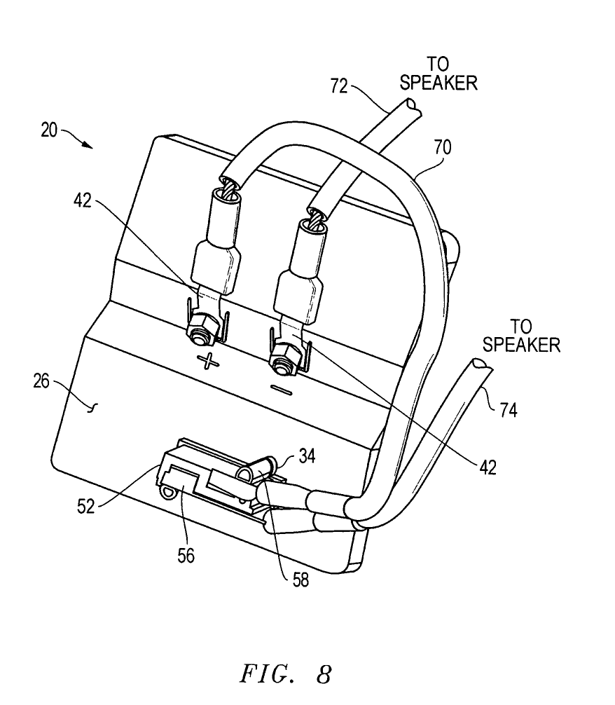

FIG. 6 is a top view of fuse receptacle 50, shown removed from fused terminal cup 20. Fuse receptacle 50 has a body 52 and an opening 54 for receiving fuse 60. A pair of fuse connectors 56 is located inside opening 54 of fuse receptacle 50 for electrical connection with fuse 60. Fuse connectors 56 extend to the outside of body 52 for electrical connection to electrical wiring components (See FIG. 8). Fuse 60 is shown removed from fuse receptacle 50, and in alignment for insertion into fuse receptacle 50.

FIG. 7 is an end view of fuse receptacle 50. Fuse connectors 56 are shown extending from body 52. In a preferred embodiment, a pair of fastener receptacles 58 are attached to body 52 and are adapted to receive fasteners 36 (see FIG. 3) to removably secure fuse receptacle 50 to base 22.

FIG. 8 is an isometric view of interior side 26 of fused terminal cup 20. An electrical wire 70 is connected between one terminal strip 42 and one fuse connector 56. An electrical wire 72 is connected between the other terminal strip 42 and speaker 12. Another electrical wire 74 is connected between the other fuse connector 56 and speaker 12. In this manner, fuse 60 is placed in the electrical circuit between terminal connectors 40 and speaker 12.

### OPERATION OF THE INVENTION

The present invention discloses a novel speaker connection device. Unique to this invention, speaker assembly 10 includes fused terminal cup 20 having fuse receptacle 50 for receiving fuse 60 in a manner which permits access to fuse 60 from the outside of speaker assembly 10. In the preferred embodiment, base 22 is dimensioned to cover a corresponding opening in speaker enclosure 14.

On terminal cup 20, terminal connectors 40 extend from exterior 24 of base 22 to interior 26 of base 22. In a preferred embodiment, terminal connectors 40 are comprised of a separate exterior portion that is electrically connected to an internal portion, or terminal strips 42. In a preferred embodiment, terminal connectors 40 are connected to terminal strips 42 by terminal fasteners 44. This configuration permits interchangeability of different types of terminal connectors 40 for attachment to terminal cup 20.

Terminal connectors 40 may be any type of connector suitable for securing speaker wires in electrical connection. Various types of connectors are commonly known and commercially available, such as RCA connectors, spring-clip or push-type, banana plug, and screw on.

Fuse receptacle 50 is located on terminal cup 20. Fuse receptacle 20 is adapted to receive removable fuse 60 in electrical connection with fuse connectors 56. In the preferred embodiment, fuse receptacle 50 is removably attached to terminal cup 20. This configuration permits interchangeability of different types of fuse receptacles 50 as compatible with the selected fuse 60 type for the application, such as AGU, MAXI, ANL, or another type of fuse.

In a preferred embodiment, base 22 has fastener holes 34 for receiving fasteners 36 to secure fastener receptacle 58 to fuse receptacle 50. Attaching fasteners 36 in this manner secures fuse receptacle 50 to base 22 of terminal cup 20. Removal of fasteners 36 permits removal of fuse receptacle 50 for interchanging with a fuse receptacle 50 of a different type. When secured to base 22, opening 54 of fuse receptacle 50 is aligned with slot 32 of base 22 to permit insertion of fuse 60.

One of fuse connectors 56 is electrically connectable to one of terminal connectors 40. In this manner, fuse 60 is placed in the electrical circuit between terminal connectors 40 and speaker 12. If the amplifier power to speaker 12 exceeds the rating of fuse 60, fuse 60 will burn, resulting in disconnection of the electrical circuit and termination of electrical power supplied to speaker 12. In this manner, the speaker and speaker components are protected. This can be a relatively frequent occurrence when custom subwoofer speaker assemblies are used. The unique benefit of this design is that fuse 60 can be removed and replaced without any need to disassemble speaker assembly 10. Another benefit is that a single unit terminal cup 20 can be installed in a single opening in speaker enclosure 14.

In a preferred embodiment, terminal connectors 40 are located in a recess 30. This configuration prevents interference of electrically connected terminal connectors 40 with other objects in the vicinity of outside 18 of speaker enclosure 14.

In another preferred embodiment, opening 54 of fuse receptacle 50 is aligned with slot 32 on base 22. Body 52 extends to the interior side 26 of terminal cup 20, on inside 16 of speaker enclosure 14. This configuration prevents interference of electrically connected fuse connectors 56 with other objects in the vicinity of outside 18 of speaker enclosure 14.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

I claim:

1. A fused speaker enclosure terminal cup, comprising:
a base, having an interior and an exterior;
a pair of terminal connectors extending from the exterior to the interior of the base;
a fuse receptacle attached to the base, having a pair of fuse connectors;
the fuse receptacle adapted to receive a removable fuse in electrical connection with the fuse connectors; and,
one of the fuse connectors being electrically connectable to one of the terminal connectors.

2. The device of claim 1, further comprising:
wherein the terminal connectors are removably attached to the base of the terminal cup.

3. The device of claim 1, further comprising:
wherein the fuse receptacle is removably attached to the base of the terminal cup.

4. The device of claim 1, each terminal connector further comprising:
an external portion attached to the base exterior; and,
a terminal strip attached to the base interior, electrically connected to the external portion.

5. The device of claim 1, further comprising:
a recess located on the base; and,
wherein the terminal connectors are attached within the recess.

6. The device of claim 1, the fuse receptacle further comprising:
an opening aligned with a slot on the base; and,
a body extending to the interior side of the base.

7. The device of claim 1, further comprising:
wherein the base is dimensioned to cover a corresponding opening in a speaker enclosure.

8. An externally fused speaker system, comprising:
an enclosure having an inside and an outside;
a speaker attached to the enclosure;
a terminal cup attached to the enclosure, having an interior and an exterior;
a pair of terminal connectors attached to the terminal cup, extending between the interior and the exterior;
a fuse receptacle on the terminal cup;
a pair of fuse connectors attached to the receptacle;
an opening of the fuse receptacle adapted to receive a removable fuse in electrical connection with the fuse connectors;
an electrical conductor extending from one terminal connector to the speaker;
an electrical conductor extending from the other terminal connector to one of the fuse connectors;
an electrical conductor extending from the other fuse connector to the speaker; and,
wherein a fuse may be inserted or removed from the fuse receptacle from the outside of the enclosure.

9. A terminal cup for selectively securing each of a pair of speaker wires in electrical communication with a speaker in a speaker enclosure having an interior and an exterior, the terminal cup comprising:
a base dimensioned to cover a corresponding opening in the speaker enclosure;
a pair of terminal connectors carried by the enclosure, each terminal connector for connection to one of the speaker wires;
speaker wires extending from the terminal connectors to the speaker; and
a fuse receptacle carried by the base, the fuse receptacle for receiving a fuse and placing the fuse in electrical communication between at least one of the speaker wires and the speaker.
